(19) United States
(12) Patent Application Publication
(10) Pub. No.: US 2026/0117075 A1
(43) Pub. Date: Apr. 30, 2026

(54) COATING COMPOSITION

(71) Applicants: VOESTALPINE STAHL GMBH, Linz (AT); SALZGITTER FLACHSTAHL GMBH, Salzgitter (DE); MERCEDES-BENZ GROUP AG, Stuttgart (DE); G & S SOLUTION GMBH, Bruchsal (DE)

(72) Inventors: Robert MAYRHOFER, Sindelfingen (DE); Frank BEIER, Stauffenberg (DE); Karl-Heinz STELLNBERGER, Linz (AT); Georg GROS, Bruchsal (DE)

(21) Appl. No.: 19/115,707

(22) PCT Filed: Sep. 25, 2023
(86) PCT No.: PCT/EP2023/076402

§ 371 Date: Mar. 26, 2025

(30) Foreign Application Priority Data
Sep. 26, 2022 (EP) 22197814.1

(51) Int. Cl. C09D 5/08; C09D 5/24; C09D 7/20; C09D 7/61; C09D 161/04; C09D 163/00; C09D 175/00; C23F 11/173; H01M 50/119; H01M 50/121; H01M 50/124

(52) U.S. Cl. CPC C09D 5/084; C09D 5/24; C09D 7/20; C09D 7/61; C09D 161/04; C09D 163/00; C09D 175/00; C23F 11/173; H01M 50/119; H01M 50/121; H01M 50/1245

(57) ABSTRACT

A composition for coating metal surfaces includes a binding agent having a phenolic resin, an epoxy resin, in particular phenoxy resin, a polyester resin (soft resin) and a polyisocyanate, further having at least one conductive pigment, a corrosion resistant pigment and a solvent. The coating layer obtained from the composition by drying is corrosion-resistant, non-flammable, forming-compatible and weldable.

### CROSS REFERENCES

This application is a U.S. National Phase Application of International Application No. PCT/EP2023/076402 filed Sep. 25, 2023, which claims priority to European Application No. 22197814.1 filed Sep. 26, 2022, the disclosures of each of which are hereby incorporated by reference herein in their entirety.

### TECHNICAL FIELD

The present disclosure relates to a coating composition for metal surfaces, in particular battery casings in battery-powered vehicles. The present disclosure also relates to a method for coating metal surfaces, a metal sheet coated with the composition, an object coated with the composition, and a battery casing with a coated surface.

### BACKGROUND

Battery-powered vehicles are an environmentally friendly form of personal transportation. To further improve the safety of battery-powered vehicles, the batteries must be efficiently protected against corrosion and mechanical damage. It is also important to protect the passengers and interior of the vehicle from fires that could be caused by the batteries overheating.

To achieve this, batteries are normally enclosed in battery casings, usually made of steel. These casings must have appropriate corrosion protection, as well as protection against thermal effects resulting from overheated batteries. In the prior art, complex layers of insulation are incorporated in the batteries, or multiple layers of lacquer are applied to the casings, the first of which is usually a cathodic electrophoretic deposition (cathodic EPD). The lacquer coatings should display an appropriate adhesion when threaded fasteners are screwed into it, and tolerance to damages occurring during transportation.

The following approaches to protecting batteries in electric vehicles are used in the prior art:

DE 102018203921 A1 discloses a motor vehicle, the body or battery housing of which is coated with an intumescent flameproof coating, which contains a polyurethane that foams up in the event of a fire.

There are other coating systems from the prior art that are also used in vehicle manufacturing:

EP 2 016 138 discloses an anticorrosion system for metal, the composition of which contains a binder, in particular a polyester resin.

EP 1 030 894 discloses an anticorrosion composition that contains a binder made of polyester resins and/or epoxy resins.

There is still the need for environmentally safe compositions that are easy to use for coating metal surfaces, in particular battery casings, which are corrosion-resistant, malleable, weldable, and nonflammable.

### SUMMARY

The object of the present disclosure is to therefore create a coating composition that provides better protection for a vehicle battery and increases operational safety for battery-powered vehicles.

To achieve this object, a composition for coating metal surfaces is disclosed that comprises the following:
a) a binder containing
   2 to 15% by weight phenol resin,
   1 to 10% by weight epoxy resin
   0.1 to 5% by weight polyester resin,
   1 to 10% by weight polyisocyanate,
b) 50 to 90% by weight of at least one conductive pigment, and
   0.1 to 15% by weight of an anticorrosion pigment,
   wherein all of the percentages relate to the solid, and
c) 5-80% by weight of a solvent, in relation to the overall composition.

This composition results in a particularly environmentally friendly coating for metal surfaces.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

The solids, i.e. the non-volatile components are determined according to DIN EN ISO 3251:2019. For this, 1 g of the composition is heated in a convection oven for 1 hour at 120° C., and subsequently weighed. This definition of the “solid” is used for all of the following.

After applying the composition, and drying or curing thereof, the solvent evaporates, forming a dry lacquer coating. The binder contains numerous components. Phenol resins are synthetic resins obtained by polycondensation of phenols and aldehydes, in particular formaldehyde. Epoxy resins are synthetic resins that contain an epoxide group that opens up and cross-links during the curing process. Polyester resins are synthetic resins that are obtained through polycondensation of bivalent or multivalent alcohols and dicarboxylic acids. Polyisocyanates are organic compounds containing two or more isocyanate groups and are therefore highly reactive. Additive reactions take place during the curing process. A matrix is formed by cross-linking of the components during the curing process. The binder thus forms a polymer with a thermosetting matrix. The pigments are embedded in the matrix. The conductive pigment contains electrically conductive particles.

The composition is particularly ideal for obtaining a coating with a dry film thickness of 2 to 20 μm.

The lacquer coating adheres to a wide variety of surfaces, of which metal surfaces of aluminum, aluminum alloys or steel, particularly electrolytic galvanized steel, hot dipping galvanized steel, zinc/magnesium galvanized steel, zinc/aluminum galvanized steel, zinc/iron galvanized steel, or ungalvanized steel, are particularly ideal. This composition is suitable for coating various steel products, e.g. deep-drawn products as well as ultra-high-strength materials.

The lacquer coating is extremely corrosion resistant, and prevents surface, contact, and flange corrosion. The composition is therefore ideal for components made of a variety of materials, which need to be protected against contact corrosion. Because the composition is intended for coating a metal surface, corrosion protection can also be obtained in areas where a subsequent application of lacquer is unable to reach, e.g. on flanges. It is also possible to use the composition as a replacement for a cathodic EPD coating.

Another advantage is that the lacquer coating is difficult to ignite. In particular, it will not even ignite on a metal that is red hot, and will not continue to burn on its own, resulting in a lacquer coating that remains nonflammable at temperatures of 950° C. and higher. This can be determined by heating a coated metal with a Bunsen burner.

The resulting lacquer coating can be further processed in a variety of ways. It can be welded (withstands spot welding), even at 50 Hz processes, threaded fasteners can be screwed into it, and it can be glued, even with high-strength adhesives. It can also be phosphatized, and cathodic EPD can be applied thereto without reacting with the phosphatization. A coated metal sheet can be shaped if necessary, without supplementary oiling, in a deep drawing process, without damaging the lacquer coating.

The coating will also not become electrostatically charged. It is also resistant to chemicals such as alkaline cleaning agents, mild acids and organic solvents.

Because the lacquer coating that is obtained is adhesive, easily shaped, extremely difficult or impossible to ignite, corrosion resistant, and weldable, this composition is particularly suitable for coating battery casings. It can also be used for a number of applications in the fields of electronics and construction.

If the conductive pigment contains zinc and/or aluminum, or is composed thereof, the composition is particularly suitable for welding. These conductive pigments also improve the corrosion protection. Powdered conductive pigments are ideal.

A composition in which the conductive pigment is a spherical powder is ideal. The weldability is improved in particular when the particle size d(100) is 35 μm to 45 μm, and/or d(99) from 20 μm to 25 μm, and/or d(50) from 3.6 μm to 4.7 μm. The distribution of the particle sizes can be determined using laser diffractometry according to ISO 13320:2020.

Weldability is improved if some of the conductive pigments protrude from the lacquer coating. Weldability is therefore improved if 0.001% to 1.0% by weight of the particles in the conductive pigment have a particle size of 20 μm to 45 μm, in particular 20 μm to 35 μm. The particle sizes can be measured according to ISO 3549:1995.

For a particularly good weldability, the conductive pigment can comprise 50.0% to 90.0% by weight, in particular 60.0% to 85.0% by weight, preferably 70.0% to 80.0% by weight, in relation to the solid.

To improve the corrosion protection of the lacquer coating, the composition contains at least one anticorrosion pigment. The anticorrosion pigment differs from the conductive pigment. Ideally, the composition contains an anticorrosion pigment comprising zinc phosphate, aluminum triphosphate, zinc oxide or silicate. The corrosion protection is particularly good when the anticorrosion pigment is a silicate, in particular a silicate modified with calcium, preferably with a particle size of d(50) 2.5 μm to 4.0 μm.

A particularly effective corrosion protection can be obtained with an anticorrosion pigment content of 0.1% to 15.0% by weight, in particular 2.5% to 10.0% by weight, preferably 5.0% to 9.0% by weight in relation to the solid.

A composition containing bentonite, in particular with a content of 0.25% to 1.5% by weight in relation to the solid, is particularly advantageous. This results in a particularly stable and durable composition, with which the properties of the lacquer coating can be improved. Bentonite has the CAS number 1302-78-9.

The composition is also particularly stable and durable if it contains a pyrogenic silicon dioxide, in particular with a content of 0.25% to 1.5% by weight in relation to the solid. This can also improve the properties of the lacquer coating. Pyrogenic silicon dioxide has the CAS number 112945-52-5.

The properties of the composition and the lacquer coating can also be improved by the binder. A binder that contains phenol resin, epoxy resin, polyester resin, and polyurethan is particularly ideal.

A composition in which the phenol resin content is 2.0% to 15.0% by weight, in particular 4.0% to 10.0% by weight, preferably 6.0% to 8.0% by weight in relation to the solid has proven to be particularly ideal.

This can contain 30% to 40% by weight, in particular 35% to 37.5% by weight phenol resin in relation to the binder.

A composition in which the epoxy resin content is 1.0% to 10.0% by weight, in particular 2.5% to 7.5% by weight, preferably 4.0% to 6.0% by weight in relation to the solid is particularly ideal.

The epoxy resin content can also be 25% to 35% by weight, in particular 30% to 33% by weight in relation to the binder.

The epoxy resin can also be a polyether with a bisphenol basis, in particular bisphenol A, and epichlorhydrin.

Compositions in which the epoxy resin is a phenoxy resin have proven to be particularly ideal. A phenoxy resin with a molar mass of 52,000 to 60,000 Dalton, preferably a molar mass of 52,000 to 55,000 Dalton is preferred for this. The molar mass is determined according to DIN EN ISO 16014-5:2012.

A composition in which the polyester resin content is 0.1% to 5.0% by weight, in particular 0.3% to 3.0% by weight, preferably 0.5% to 2.0% by weight in relation to the solid has proven to be particularly ideal. This polyester resin advantageously increases the elasticity, thus improving the fracture pattern when gluing the coating. Abrasion on the shaping tool can also be reduced, advantageously increasing the service life of the tool.

The polyester resin content can advantageously be 0.1% to 20.0% by weight, in particular 0.5% to 10.0% by weight, preferably 5.0% by weight in relation to the binder.

The polyester resin preferably has a molar mass of 5,000 to 25,000 Dalton, in particular 7,000 Dalton. This molar mass can also be determined according to DIN EN ISO 16014-5:2012.

A composition in which the polyisocyanate is an aliphatic polyisocyanate has proven to be particularly preferable.

It has also proven to be particularly preferable if the polyisocyanate content is 2.5% to 6.5% by weight, preferably 3.5% to 5.5% by weight in relation to the solid.

The polyisocyanate content can advantageously be 20.0% to 30.0% by weight, in particular 25.0% to 28.0% by weight, preferably 27.5% by weight in relation to the binder.

It can also contain a blocked polyisocyanate, in particular with a deblocking temperature of >140° C. In this case, it is preferred that the blocked polyisocyanate have an isocyanate content of 4.5% to 12%, in particular 8.0% to 9.0% in relation to the overall mass of the polyisocyanate.

The composition can also contain an unblocked polyisocyanate. In this case, it is particularly preferable when the unblocked polyisocyanate has an isocyanate content of 15% to 25% in relation to the polyisocyanate.

It has proven to be particularly ideal when the composition contains a blocked polyisocyanate and an unblocked polyisocyanate.

A composition in which the binder forming the polymer matrix is composed exclusively of a phenol resin, an epoxy resin, a polyester resin, and a polyisocyanate has proven to be particularly ideal. In this case, it is particularly preferable when the components exhibit the properties listed above. It is therefore preferred that the epoxy resin is a phenoxy resin. The polyisocyanate is also preferably an aliphatic polyisocyanate. This results in a lacquer coating that is particularly difficult to ignite, can be easily shaped, and adheres well.

The composition and lacquer coating have proven to have particularly advantageous properties when the ratio of binder to the pigments in % by weight ranges from 1.0:2.0 to 1.0:6.0, in particular 1.0:4.0 to 1.0:6.0, preferably 1.0:4.0 to 1.0:5.0, and more preferably 1.0:4.0 to 1.0:4. 6.

A surfactant, in particular a block copolymer with pigment affinity groups, preferably a low-molecular unsaturated polycarbonic polymer, can be contained in the composition to improve the properties of the composition and lacquer coating. If it contains a surfactant, it is particularly preferable when the surfactant content is 0.1% to 2.0% by weight, in particular 0.1% to 1.0% by weight, preferably 0.1% to 0.25% by weight in relation to the solid.

The surfactant content can also be 0.01% to 1.0% by weight, in particular 0.1% to 0.8% by weight, in relation to the pigment. The surfactant content can also be 1.0% to 4.0% by weight, in particular 2.5% to 3.7% by weight, in relation to the binder.

If the composition contains a defoamer, the content thereof is particularly preferably 0.01% to 2.0% by weight, in particular 0.1% to 1.0% by weight, preferably 0.1% to 0.25% by weight, in relation to the solid.

An adhesive, easily shaped, particularly difficult or impossible to ignite, corrosion resistant and readily weldable lacquer coating can be obtained with a composition containing 2% to 15% by weight phenol resin, 1% to 10% by weight epoxy resin, 0.1% to 5% by weight polyester resin, 1% to 10% by weight polyisocyanate, 50% to 90% by weight conductive pigment, and 0.1% to 15% by weight anticorrosion pigment, in relation to the solid.

In particular, the composition can contain other components, e.g. surfactant, in particular with a content of 0.1% to 2.0% by weight in relation to the solid, and/or defoamer, in particular with a content of 0.05% to 1.5% by weight in relation to the solid.

It has proven to be particularly advantageous when these components exhibit the properties listed above.

The composition is particularly stable and easy to process when the solid content is 20% to 95% by weight, in particular 30% to 85% by weight, preferably 40% to 75% by weight, in relation to the overall composition, i.e. including the solvent.

The composition can be readily processed and is particularly durable when the solvent is an ester, in particular a methoxy propyl acetate and/or butyl diglycol acetate, a ketone, in particular cyclohexanone, aromatic hydrocarbon, in particular solvent naphtha, and mixtures thereof. This also simplifies processing of the composition, and results in a shorter curing time.

A composition in which the solvent is a butyl diglycol acetate, methoxy propyl acetate, or a mixture thereof has proven to be particularly ideal.

A composition in which the solvent content is 15% to 70% by weight, preferably 25% to 60% by weight, more preferably 30%, in relation to the overall composition is also particularly advantageous.

The composition is particularly durable and stable when it is produced in a process comprising the following steps:
a) mixing the phenol resin with a portion of the solvent, in particular while adding additives,
b) adding anticorrosion pigment, and preferably wet milling the mixture, in particular to a fineness of 1 μm to 10 μm,
d) adding the conductive pigment and the rest of the binder, the epoxy resin, polyester resin, and polyisocyanate, while stirring,
e) adding the rest of the solvent,
f) filtering the composition.

The fineness of the wet milling is determined in the Hegmann grindometer according to DIN 53203.

The aforementioned surfactants and/or defoamers and/or pyrogenic silicon dioxide in particular can form the additives.

The composition may have many uses, one of which is for coating metal sheets in a coil-coating process, spraying process, or immersion process. The composition can also be used for coating metal objects with a spraying process or immersion process.

Metal surfaces that are particularly ideal for coating with the composition obtained with the present disclosure include aluminum, aluminum alloys, and steel, in particular electrolytically galvanized steel, hot dipped galvanized steel, zinc/magnesium galvanized steel, zinc/aluminum galvanized steel, zinc/iron galvanized steel, or ungalvanized steel.

A particularly quick and simple method for coating a metal surface is characterized in that the metal surface is coated with the composition described above, and the composition is baked at temperatures of 140° C. to 260° C. for the peak metal temperature, wherein the baking time lasts 15 to 60 seconds. The peak metal temperature can be determined with temperature measuring tapes. It is also possible to take measurements with an infrared thermometer.

The adhesion of the lacquer coating is particularly good when the metal surface is made of a galvanized, alloy galvanized, or ungalvanized steel or aluminum or an aluminum alloy. The adhesion can be further improved if the metal surface comprises a base coat, in particular without chrome. The base coat is ideally a chemical anticorrosion treatment containing no substances banned by ELV RL 2000/53/EG or RoHS RL 2011/65/EU.

The present disclosure also relates to a metal sheet or metal object that can be obtained with the method described above.

According to the present disclosure, this comprises a metal sheet or object, in particular a battery casing, which has a coating comprising an isocyanate cross-linked, thermoplastic matrix that contains a phenol resin, polyester resin, epoxy resin, in particular a phenoxy resin, and a conductive pigment suspended in the thermoplastic matrix, and an anticorrosion pigment suspended in the thermoplastic matrix.

The components of the coating can exhibit the properties listed above in reference to the composition. Furthermore, the coating can also contain the components of the composition listed above as optional. A particularly ideal embodiment therefore relates to a metal sheet or object with a coating that also contains a surfactant and/or a defoamer, and/or pyrogenic silicon dioxide, preferably with the special properties listed above. This coating is particularly ideal for battery casings.

A particularly good corrosion protection, malleability, and weldability have been obtained with a metal sheet or object in which the thickness of the coating is 2 μm to 20 μm, in particular 4 μm to 10 μm, preferably 6 μm to 8 μm. When the dry film is up to 8 μm thick, the lacquer coating is ideal for welding. Furthermore, with a thickness of 6 μm or more, the corrosion protection for the surface is very good.

Another aspect of the present disclosure relates to a battery casing, in particular for batteries in an electric vehicle, which comprises at least one metal surface with a coating that faces outward, i.e. away from the battery, which is the coating produced in any of the processes described above.

In addition, a battery casing, in particular for the batteries in an electric vehicle, which has a metal surface on which the coating faces outward, is obtained with the present disclosure, wherein the coating comprises an isocyanate cross-linked thermoplastic matrix, which contains a phenol resin, epoxy resin, and a polyester resin in particular, as well as a conductive pigment suspended in the matrix, and in particular an anticorrosion pigment suspended in the matrix.

It is particularly advantageous when the components exhibit the properties described above, i.e. when the epoxy resin is a phenoxy resin. In this case, the coating can also contain one of the optional components of the composition described above.

The battery casing is therefore coated with the composition described above, which has then been dried or cured.

Advantageous embodiments of the present disclosure shall be illustrated by the following examples, without limiting the general inventive concept thereto:

TABLE 1
Formulas for exemplary compositions, and comparison formulas

| | | | | | | | | |
|---|---|---|---|---|---|---|---|---|
| Formula | | | | | | | | |
| Variations | V-1 | V-2 | V-3 | V-4 | V-5 | V-6 | V-7 | V-8 |

Organic binders (calculated for 100%)

| | | | | | | | | |
|---|---|---|---|---|---|---|---|---|
| Phenol resin | 30 | 35 | 37.5 | 30 | 35 | 37.5 | 35 | 37.5 |
| Phenol resin | — | — | 30 | — | — | 30 | — | 30 |
| (MW 50,000- | | | | | | | | |
| 60,000) | | | | | | | | |
| Epoxy resin | 40 | 32.5 | — | 40 | 32.5 | — | 32.5 | — |
| (Type 1009) | | | | | | | | |
| Polyester | — | 5 | 5 | — | 5 | 5 | 5 | 5 |
| resin | | | | | | | | |
| (soft resin) | | | | | | | | |
| BL-Isocyanate | — | 27.5 | 27.5 | — | 27.5 | 27.5 | 27.5 | 27.5 |
| (Type: | | | | | | | | |
| aliphatic) | | | | | | | | |
| BL-Isocyanate | 30 | — | — | 30 | — | — | — | — |
| (Type: | | | | | | | | |
| aromatic) | | | | | | | | |

Pigments

| | | | | | | | | |
|---|---|---|---|---|---|---|---|---|
| Zn dust | 41.75 | 42 | 42 | 47.5 | 47.25 | 47.5 | 50 | 50 |
| (conductive | | | | | | | | |
| pigment) | | | | | | | | |
| Silicate | 5 | 5 | 5 | 5 | 5 | 5 | 6 | 6 |
| (anticorrosion | | | | | | | | |
| pigment) | | | | | | | | |
| Pyrogenic | 0.25 | — | — | — | 0.25 | — | — | — |
| silica | | | | | | | | |

Additives

| | | | | | | | | |
|---|---|---|---|---|---|---|---|---|
| Surfactant | 0.25 | 0.25 | 0.25 | 0.25 | 0.25 | 0.25 | 0.4 | 0.4 |
| Defoamer | 0.25 | 0.25 | 0.25 | 0.25 | 0.25 | 0.25 | 0.2 | 0.2 |

Organic solvent

| | | | | | | | | |
|---|---|---|---|---|---|---|---|---|
| Butyl diglycol | 30 | 30 | 30 | 30 | 30 | 30 | 30 | 30 |
| acetate/MPA | | | | | | | | |
| Overall Total | 100 | 100 | 100 | 100 | 100 | 100 | 100 | 100 |
| Binder:Pigment | 1.0:2.0 | 1.0:2.0 | 1.0:2.0 | 1.0:3.0 | 1.0:3.0 | 1.0:3.0 | 1.0:4.0 | 1.0:4.0 |
| % by weight | | | | | | | | |
| Solid:70% | 23.0:47.0 | 23.0:47.0 | 23.0:47.0 | 17.5:52.5 | 17.5:52.5 | 17.5:52.5 | 14.0:56.0 | 14.0:56.0 |
| by weight | | | | | | | | |

| Formula | | | | | | | |
|---|---|---|---|---|---|---|---|
| Variations | V-9 | V-10 | V-11 | V-12 | V-13 | V-14 | V-15 |
| Organic binders (calculated for 100%) | | | | | | | |
| Phenol resin | 37.5 | 37.5 | 35 | 37.5 | 35 | 37.5 | 30 |
| Phenol resin | 30 | — | — | 30 | — | 30 | 20 |
| (MW 50,000- | | | | | | | |
| 60,000) | | | | | | | |
| Epoxy resin | — | 30 | 32.5 | — | 32.5 | — | — |
| (Type 1009) | | | | | | | |
| Polyester | 5 | 5 | 5 | 5 | 5 | 5 | 20 |
| resin | | | | | | | |
| (soft resin) | | | | | | | |
| BL-Isocyanate | 27.5 | — | 27.5 | 27.5 | 27.5 | 27.5 | 30 |
| (Type: | | | | | | | |
| aliphatic) | | | | | | | |
| BL-Isocyanate | — | 27.5 | — | — | — | — | — |
| (Type: | | | | | | | |
| aromatic) | | | | | | | |
| Pigments | | | | | | | |
| Zn dust | 52.5 | 50 | 53 | 53 | 53.45 | 53.45 | 54 |
| (conductive | | | | | | | |
| pigment) | | | | | | | |
| Silicate | 5 | 7 | 5 | 5 | 5 | 5 | 5 |
| (anticorrosion | | | | | | | |
| pigment) | | | | | | | |
| Pyrogenic | — | 0.5 | 0.5 | 0.5 | 0.75 | 0.75 | 1 |
| silica | | | | | | | |
| Additives | | | | | | | |
| Surfactant | 0.4 | 0.4 | 0.4 | 0.4 | 0.4 | 0.4 | 0.4 |
| Defoamer | 0.2 | 0.2 | 0.2 | 0.2 | 0.2 | 0.2 | 0.2 |
| Organic solvent | | | | | | | |
| Butyl diglycol | 30 | 30 | 30 | 30 | 30 | 30 | 30 |
| acetate/MPA | | | | | | | |
| Overall Total | 100 | 100 | 100 | 100 | 100 | 100 | 100 |
| Binder:Pigment | 1.0:4.5 | 1.0:4.5 | 1.0:5.0 | 1.0:5.0 | 1.0:5.5 | 1.0:5.5 | 1.0:6.0 |
| % by weight | | | | | | | |
| Solid:70% | 12.5:57.5 | 12.5:57.5 | 11.5:58.5 | 11.5:58.5 | 10.8:59.2 | 10.8:59.2 | 10.0:60.0 |
| by weight | | | | | | | |

The components of the binder are indicated such that amounts relate to 100% by weight thereof. The binder amounts in the solid are given in the last row as the upper value, and the pigment amounts are the lower values. These values indicate the proportion of binder to pigment. The total indicates the sum of all parts. By way of example, a binder:pigment ratio of 1.0:4.0 indicates that there is a total of 5 parts, composed of 1 part binder and 4 parts pigment. According, with 70% by weight solid, there are 14 parts binder and 56 parts pigment. The percentage of binder is therefore 20% by weight of the solid. The amount of additives remains disregarded.

The comparison examples V1-V6 contain a portion of zinc pigment that is less than 50% by weight in relation to the solid, and the formulas V1 and V4 do not contain polyester resin.

The compositions V1-V15 are produced in a first phase by dissolving phenol resin, solvent, defoamer, and surfactant individually in a dissolver while stirring lightly, and subsequently homogenizing the mixture. The anticorrosion pigment and pyrogenic silica are then added. This is then wet milled with a bead mill (CeO₂ rod with ZrO₂ beads, 0.80-1.00 mm), wherein the mixture is ground to a fineness of <10 μm (Heman grindometer, DIN 53203).

In a second phase, the other components, i.e. the conductive pigment, remaining binders and solvent, are added slowly while stirring lightly, and homogenized in dissolver. The desired viscosity can be obtained using the solvent. The homogenized mixture is poured into a vessel while filtering with a mesh size of <80 μm (PES 80/32, 80 μm/32% open screen surface).

For the other tests, metal sheets are coated with one of the compositions V1 to V15, and the coatings are baked on. This is done for 30 seconds at 420° C. with a fan rotating at 2,000 rpm, as this corresponds to the desired peak metal temperature that is higher than 204° C. with a belt speed of 100 to 120 meters/second. The tests are then run and evaluated.

The results are shown in Table 2. To evaluate the properties of the individual compositions, they are compared with the most common reference on the market, specifically Granocoat® ZE from Henkel, with a coating thickness of 6 μm.

One of the compositions described in EP 1 030 894 could also be used as a reference.

If the properties of the respective composition are of similar quality with the same thickness, or demonstrate slightly better results than those of the reference, they receive the value “o.” With significantly better results, the value “+” is awarded, and with extremely better results, the value “++” is awarded.

TABLE 2
Schematic illustration of the properties of the dry film

| Main Properties | V-1 | V-2 | V-3 | V-4 | V-5 | V-6 | V-7 | V-8 | V-9 | V-10 | V-11 | V-12 | V-13 | V-14 | V-15 |
|---|---|---|---|---|---|---|---|---|---|---|---|---|---|---|---|
| Difficult to ignite | ∘ | ∘ | ∘ | ∘ | ∘ | ∘ | + | + | ++ | ++ | ++ | ++ | ++ | ++ | ++ |
| Flexibility | ++ | ++ | ++ | ++ | ++ | ++ | ++ | ++ | ++ | + | + | ∘ | ∘ | ∘ | ∘ |
| Weldability | ∘ | ∘ | ∘ | ∘ | ∘ | ∘ | + | + | ++ | ++ | ++ | ++ | ++ | ++ | ++ |
| Corrosion protection | + | ++ | ++ | + | ++ | ++ | ++ | ++ | ++ | + | + | ∘ | ∘ | ∘ | ∘ |

As Table 2 shows, the coatings made of the comparison formulas V-1 to V6 do not display better properties with regard to flammability and weldability than the reference coatings. The coatings obtained with the compositions V7 to V15 display good weldability properties, even at 50 Hz processes. The thickness of the lacquer is 8 μm in each of these tests.

All of the coatings provide good protection against corrosion. These coatings are therefore form good cathodic EPD substitutes. This has been tested in a salt spray test (NSS DIN EN ISO 9227), as well as with the cyclical corrosion test (DIN ISO 11997-3, DIN 55635 and VDA 233-102).

They are also flame-resistant. This has been tested with a simulated “thermal pass” of battery cells inside a battery casing. The temperate of 950° C. assumed according to the Chinese standard GB 38031-2020 is simulated with an acetylene oxygen flame on the back surface of the coated sheet metal. Even at a light yellow flame at >1,100° C., the coating does not ignite. Sheet metal coated with a commercially available cathodic electrodeposition lacquer ignites when subjected to an open, blackening flame. The coatings obtained with the compositions V7-V15 demonstrate a very high adhesion quality, and can be easily processed, as they can be readily shaped in deep drawing processes, with or without supplementary oiling, screwed together, glued together, phosphatized, and painted with cathodic EPD. They are also particularly ideal for phosphatizing.

All of the exemplary coatings demonstrate good corrosion protection, while the coatings obtained with the compositions V7 to V11 have significant advantages over the reference. Furthermore, all of the exemplary coatings are extremely flexible, since they can be readily shaped in deep drawing processes, and those obtained with the compositions V7 to V11 are particularly ideal. All of the exemplary coatings can be welded much more readily than the reference examples. Furthermore, all of the exemplary coatings demonstrate a better flame-resistance than the reference compositions.

The coatings obtained with the compositions V7 to V15 are therefore ideal for coating battery casings and could also be used for other applications that require a high level of corrosion protection, and are subjected to high mechanical and thermal loads.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1. A composition for coating metal surfaces, comprising:
a binder, comprising:
2 to 15% by weight phenol resin;
1 to 10% by weight epoxy resin;
0.1 to 5% by weight polyester resin;
1 to 10% by weight polyisocyanate;
50 to 90% by weight of at least one conductive pigment; and
0.1 to 15% by weight of an anticorrosion pigment;
wherein all of the percentages relate to the solid; and
5-80% by weight of a solvent, in relation to the overall composition.

2. The composition according to claim 1, wherein the conductive pigment content is 50.0% to 90.0% by weight.

3. The composition according to claim 1, further comprising at least one anticorrosion pigment, wherein the anticorrosion pigment is at least one of zinc phosphate, aluminum triphosphate, zinc oxide, and a silicate.

4. The composition according to claim 1, wherein the phenol resin content is 2.0% to 15.0% by weight in relation to the solid.

5. The composition according to claim 1, wherein the epoxy resin content is 1.0% to 10.0% by weight in relation to the solid.

6. The composition according to claim 1, wherein the epoxy resin is a phenoxy resin, in particular with a molar mass of 52,000 to 60,000 Dalton.

7. The composition according to claim 1, wherein the polyester resin content is 0.1% to 5.0% by weight in relation to the solid.

8. The composition according to claim 1, wherein the polyisocyanate is an aliphatic polyisocyanate, and/or wherein the polyisocyanate content is 2.5% to 6.5% by weight, in relation to the solid.

9. The composition according to claim 1, wherein the ratio of binder to pigment in by weight is 1.0:2.0 to 1.0:6.0.

10. The composition according to claim 1, wherein the solvent comprises at least one of:
an ester;
a ketone; and
an aromatic hydrocarbon.

11. A method for coating a metal surface, comprising the steps of:
coating a metal surface with a composition according to claim 1;
baking the composition at temperatures of 140° C. to 260° C. for the peak metal temperature, wherein the baking time is 15 to 60 seconds; and
shaping the metal surface to obtain a component.

12. A metal sheet or object with a coating produced according to the method of claim 11.

13. A metal sheet or object having a coating, comprising:
a thermosetting matrix, in particular an isocyanate cross-linked thermosetting matrix, comprising:
a phenol resin;
an epoxy resin, in particular a phenoxy resin; and
a polyester resin;
a conductive pigment suspended in the thermosetting matrix; and
an anticorrosion pigment suspended in the thermosetting matrix.

14. The metal sheet or object according to claim 13, wherein the coating has a thickness of 2 μm to 20 μm.

15. The metal sheet or object according to claim 12, wherein the metal sheet or object comprises a battery casing.

16. The metal sheet or object according to claim 13, wherein the metal sheet or object comprises a battery casing.
